(19) United States
(12) Patent Application Publication
(10) Pub. No.: US 2026/0075081 A1
(43) Pub. Date: Mar. 12, 2026

(54) SYSTEM AND METHOD FOR DETECTION AND MITIGATION OF COMPUTING THREATS

(71) Applicant: Gen Digital, Inc., Tempe, AZ (US)

(72) Inventors: Jonathon Salehpour, Upland, CA (US); Movses Margaryan, Encino, CA (US); JiaJia Liu, Rancho Palos Verdes, CA (US); Pengli Xiao, Irvine, CA (US); Yalan Bai, Torrance, CA (US); Brian Batovsky, Redondo Beach, CA (US)

(73) Assignee: Gen Digital, Inc., Tempe, AZ (US)

(21) Appl. No.: 18/826,753

(22) Filed: Sep. 6, 2024

(51) Int. Cl. H04L 9/40; G06F 40/126; G06F 40/14; G06F 40/279

(52) U.S. Cl. CPC H04L 63/1441; G06F 40/126; G06F 40/14; G06F 40/279

(57) ABSTRACT

A system enables a method for detecting and mitigating a computing threat. The method includes monitoring, by a computing device, a user interface of the computing device. The computing device encodes an output of the user interface to generate a text encoding. The computing device analyzes the text encoding to detect one or more triggers and performs a screen capture of the user interface to generate a screenshot responsive to the detecting the one or more triggers. The computing device transmits the screenshot via a network. The computing device receives via the network an indication based on the screenshot and controls a function of the computing device based on the indication based on the screenshot.

### FIELD OF INVENTION

The disclosure relates generally to computer security, and more particularly to identifying and protecting against computing threats.

### BACKGROUND

In the field of network communications, there are a wide range of computing threats that leverage interactions with a user to compromise the security of a computing device or data of a user. “Phishing” is one such computing threat in which an attacker tries to convince a victim to perform some dangerous action such as inserting their banking credential on an imposter (“spoofed”) website, or to perform some other action guided by the attacker's desire to exploit them. For instance, an attacker may build a spoofed website that looks like a victim's bank's website. When the victim enters their credentials via the spoofed website, the credentials are stolen and sent to the attacker so that the attacker can steal money from the bank account. Phishing electronic messages (e.g., emails, mobile text messages) are for example sent indiscriminately to a large number of potential victims and include links to spoofed websites or other network destinations where computing threats are present. Other computing threats include malware and viruses transmitted via an electronic message or via access to a website. Determining whether an electronic message or a website is legitimate or malicious can be a challenging task for even the savvy computer user. Other computing threats may be caused by bugs in a software application or misuse of a software application, resulting for example in loss of data or system vulnerabilities.

### SUMMARY

This Summary introduces simplified concepts that are further described below in the Detailed Description of Illustrative Embodiments. This Summary is not intended to identify key features or essential features of the claimed subject matter and is not intended to be used to limit the scope of the claimed subject matter.

A method is provided. The method includes monitoring, by a computing device, a user interface of the computing device. The computing device encodes an output of the user interface to generate a text encoding. The computing device analyzes the text encoding to detect one or more triggers and performs a screen capture of the user interface to generate a screenshot responsive to the detecting the one or more triggers. The computing device transmits the screenshot via a network. The computing device receives via the network an indication based on the screenshot and controls a function of the computing device based on the indication based on the screenshot.

Also provided is a method for mitigating a computing threat. The method includes monitoring a user interface of a computing device, encoding an output of the user interface to generate a text encoding, analyzing the text encoding to detect one or more triggers, and performing a screen capture of the user interface to generate a screenshot responsive to the detecting the one or more triggers. The method further includes applying a model to detect a computing threat and controlling a function of the computing device based on the detecting the computing threat.

Also provided is a network-enabled threat mitigation system including a first computing system including at least a first processor and at least a first non-transitory computer readable storage medium having encoded thereon first instructions that when executed by the at least the first processor cause the first computing system to perform a first process. The first process includes monitoring a user interface of the first computing system and encoding an output of the user interface to generate a text encoding. The first process also includes analyzing the text encoding to detect one or more triggers, performing a screen capture of the user interface to generate a screenshot responsive to the detecting the one or more triggers, and transmitting the screenshot via a network. The first process further includes receiving via the network an indication based on the screenshot and controlling a function of the first computing system based on the indication based on the screenshot.

Further provided is a non-transitory computer-readable storage medium storing executable instructions that, as a result of execution by one or more processors of a computing device, cause the computing device to perform operations. The operations include monitoring a user interface of the computing device and encoding an output of the user interface to generate a text encoding. The operations also include analyzing the text encoding to detect one or more triggers, performing a screen capture of the user interface to generate a screenshot responsive to the detecting the one or more triggers, and transmitting the screenshot via a network. The operations further include receiving via the network an indication based on the screenshot and controlling a function of the computing device based on the indication based on the screenshot.

### BRIEF DESCRIPTION OF THE DRAWINGS

A more detailed understanding may be had from the following description, given by way of example with the accompanying drawings. The Figures in the drawings and the detailed description are examples. The Figures and the detailed description are not to be considered limiting and other examples are possible. Like reference numerals in the Figures indicate like elements wherein:

FIG. 1 shows an environment in which a network-connectable processor-enabled security manager facilitates assessing network-based threats to a computing device which executes a security agent configured to detect and mitigate computing threats.

FIG. 2 shows a process flow enabled by the security manager and the security agent of FIG. 1 for detecting and mitigating computing threats.

FIGS. 3 and 4 are diagrams showing methods for detecting and mitigating computing threats.

FIG. 5 shows a computer system for performing described methods according to illustrative embodiments.

### DETAILED DESCRIPTION OF ILLUSTRATIVE EMBODIMENTS

Detection of computing threats often requires significant computing resources using large and complex models. Detection of computing threats is typically time sensitive in that it is beneficial for a user faced with a computing threat to be made aware of the threat as soon as possible to avoid the user taking an action which could compromise their computing device or result in exfiltration of sensitive user data. Computing devices operated by the typical user (e.g., personal computers, mobile smart devices) are often of relatively modest computing power and storage capabilities and unable to store or apply the large and complex models useful for identifying computing threats. Moreover, transmitting data from a user's computing device to a more robust computing system for determining potential computing threats is potentially resource intensive requiring significant amounts of computing resources including communication bandwidth and device power especially if transmitting data continuously. If a user's computing device is configured to locally apply a model for identifying computing threats, it is beneficial that the user's computing device apply the model sparingly to conserve computing resources. It is especially important to conserve computing resources when a computing device is battery powered to prevent quickly draining the computing device's battery.

Described herein are systems that enable methods in which a set of application-specific rules are applied for detecting when a display screen of a computing device shows potentially important or critical information. The content of a display screen is encoded, and an automated screen capture is performed to generate a screenshot when the encoded content of the device display screen matches one or more rules. The screenshot is transmitted to a remote network located system for analysis. Alternatively, the screenshot is analyzed locally on the computing device. By implementing the herein described methods via herein described computing systems, processor loading, energy requirements, communication bandwidth, and data storage requirements are minimized. These benefits arise from implementing a rules-based approach to generating screenshots to minimize the quantity of screenshots generated, transmitted, and analyzed.

As described herein, reference to “first” and “second” components (e.g., a “first computing system,” a “second computing system”) or “particular” or “certain” components or implementations (e.g., “particular triggers,” a “particular computing device,”) is not used to show a serial or numerical limitation or a limitation of quality but instead is used to distinguish or identify the various components and implementations.

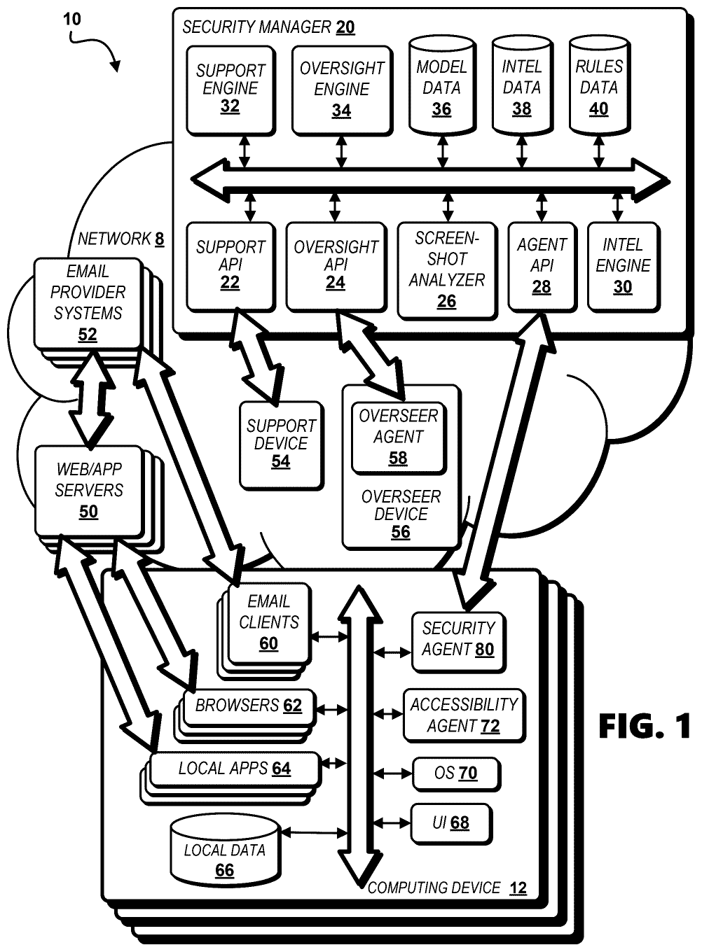

Referring to FIG. 1, an environment 10 enabled by a computer network 8 is illustrated in which a network-connectable processor-enabled security manager 20 facilitates detecting threats to users of computing devices 12. The computer network 8 includes one or more wired or wireless networks or a combination thereof, for example a local area network (LAN), a wide area network (WAN), the internet, mobile telephone networks, and wireless data networks such as Wi-Fi™ and 3G/4G/5G cellular networks. A security agent 80 enables monitoring of communications of email clients 60, browser applications (“browsers”) 62, and other local applications 64 (e.g., a social media application, an electronic messaging application) on a computing device 12. The security agent 80 further enables aggregating of email data and browsing history and clickstreams of a user on the computing device 12 and storing of aggregated information in a local datastore 66. Monitoring by the security agent 80 provides the security manager 20 with intelligence data including data files and ordered sequences of hyperlinks included in emails or followed by a user at one or more websites or other network destinations. Data gathered by the security agent 80 is transmitted by the security agent 80, is received by the security manager 20 via an agent application program interface (“API”) 28, and is stored in de-identified form in an intelligence datastore 38.

The security agent 80 implements an accessibility agent 72 to monitor information displayed to a user by a user interface 68 via a display screen. The security agent 80 instructs the accessibility agent 72 to parse content displayed by the user interface 68 to encode the content to generate a text encoding. The security agent 80 applies one or more rules to run against the encoded content, for example to determine whether the information on the display screen is critical, important, or relevant to the security agent 80. If application of the one or more rules results in a match, for example indicating that the information on the display screen of the user interface 68 is critical, important, or relevant, the security agent 80 instructs the accessibility agent 72 to perform a screen capture to generate a screenshot. As described herein, a rule match constitutes a trigger. The one or more rules applied by the security agent 80 are selected from pre-defined rules directly embedded in the security agent 80 or rules remotely configured by the security manager 20 via a screenshot analyzer 26 and downloaded by the security agent 80 from a rules datastore 40 occasionally or periodically via the agent API 28. The one or more rules are stored in the local datastore 66 for retrieval by the security agent 80.

The rules applied by the security agent 80 to the text encoding for determining that a screen capture should be performed include for example rules for determining that a display screen of the user interface 68 includes specific key words or types of text (e.g., URLs, phone numbers, or addresses) or that the display screen shows output generated via a particular grayware application that is requesting personal information. A rule can further indicate that a screen capture should not be performed when any URLs are clipped or when other text is clipped in the display screen, since such information may be relevant to an analysis of the screenshot. A rule can further indicate that a screen capture should be performed when URLs are not clipped or when text is not clipped in the display screen. The rules are beneficially application specific. For example, rules applied to display outputs originating from an email client 60 can be different from rules applied to display outputs originating from a browser 62 or other local application 64.

The rules allow the security agent 80 to detect information important or critical to the security agent 80. The rules depend on the task to be performed by the security agent 80. For example, a security agent 80 functioning to detect malware via a screenshot analyzer 26 can apply different rules than rules applied by a security agent 80 enabling oversight by a parent via an overseer device 56 or rules applied by a security agent 80 enabling technical support via a technical support staff via a support device 54. Rules can be applied for example as XPath™ rules, regular expressions, Lua™ script, or JavaScript™ script.

Rules can include rules satisfying a trigger based on a display screen including one or more particular key words, for example “urgent,” “payment,” or “immediately.” Rules can also include rules satisfying a trigger based on particular interactions in an electronic message such as an electronic chat conversation or email, for example an interaction in which a party is requesting personal information from a user of the computing device 12. Rules can further include rules satisfying a trigger based on particular text in a display screen being fully visible and not clipped, for example a rule requiring a URL to be fully visible to effectively determine if the URL corresponds to phishing or other malicious activity.

Rules can be applied by the security agent 80 to the accessibility agent 72. The accessibility agent 72 is enabled to perform a screen capture of the user interface 68 including contents of a display screen responsive to one or more rules satisfying a trigger to generate a screenshot. Alternatively, the security agent 80 performs the screen capture to generate the screenshot. The security agent 80 transmits the screenshot to the security manager 20 via the agent API 28, and the screenshot analyzer 26 applies a model from a model datastore 36 to the screenshot to determine whether the screenshot corresponds to a computing threat (e.g., a phishing attempt). If a computing threat is determined, the screenshot analyzer 26 via the agent API 28 transmits an indication of the computing threat to the security agent 80 via the agent API 28. Alternatively, the security agent 80 locally applies a model from the model datastore 36 or the local datastore 66 to the screenshot to determine whether there is a computing threat. The model can incorporate for example one or more of a convolution neural network (“CNN”), a long short-term memory artificial recurrent neural network (“LSTM RNN”), a support vector machine (“SVM”) algorithm, a k nearest neighbor (“KNN”) algorithm, or a large language model (“LLM”).

In an alternative implementation, the security manager 20 via an oversight engine 34 alternatively or additionally transmits the screenshot received from the security agent 80 to an overseer device 56 (e.g. a personal computer, a mobile communication device, a network-based computing interface) via an oversight application program interface (“API”) 24 of the security manager 20 and via an overseer agent 58 executed by the overseer device 56. The overseer device 56 is operated for example by a parent of a user of the computing device 12. One or more rules for triggering the screen capture of the screenshot include for example one or more rules detecting harassment or predatory language in the text encoding of the displayed content in the display screen of the user interface 68. The screen capture of the screenshot can further be triggered based on detected images in the displayed content, for example detected images of a potentially harassing or explicit nature. The captured screenshot is displayed to the user of the overseer device 56 via the overseer agent 58 via a display screen of the overseer device 56. The user of the overseer device 56 is enabled to communicate an indication to the oversight engine 34 via the overseer agent 58 and via the oversight API 24 of whether the screenshot represents a threat or not, for example whether the screenshot includes harassing or threatening language or images. The security manager 20 via the oversight engine 34 and via the agent API 28 transmits an instruction to the computing device 12 via the security agent 80 to block a communication or application associated with the screenshot based on an indication from the user of the overseer device 56 that the screenshot represents a threat, and the security agent 80 blocks the communication or application based on the indication. The security agent 80 further provides a notification to the user of the computing device 12 via the display screen of the user interface 68 based on the indication, for example a notification explaining the blocking of the communication or application.

The security manager 20 aggregates electronic data including screenshots from a plurality of computing devices 12 via the security agent 80 executed on the plurality of computing devices 12 for the purpose of training one or more models for identifying security threats. The security manager 20 via the intelligence engine 30 aggregates data including screenshots triggered based on particular rules applied to text encodings of user interfaces 68 of computing devices 12 to perform a training process. Screenshots triggered based on rules corresponding to a high likelihood of a computing threat are labeled as corresponding to threats during training of a model by the intelligence engine 30. For example, screenshots of emails from a known malicious sender or screenshots of webpages at known high-risk URLs are labeled as threats during training of a model. Screenshots triggered based on rules corresponding to a low likelihood of a computing threat are labeled as corresponding to non-threats during training of a model. For example, screenshots of emails from known safe senders (government organization senders) or screenshots of webpages at known low-risk URLs (government organization URLs) are labeled as corresponding to non-threats during training of a model. Training processes performed by the intelligence engine 30 are implemented concurrently with threat detection and mitigation processes performed by the security agent 80 via the security manager 20 on computing devices 12 to continually update one or more models for threat detection.

The security agent 80 monitors communications of the email clients 60, the browsers 62, and the local applications 64 via the accessibility agent 72. The security agent 80 monitors via the browser 62 via the accessibility agent 72 communications including user activity on network-based applications and websites enabled by the web or application (“web/app”) servers 50 including browser-based email services (e.g., GMAIL™, YAHOO MAIL™) enabled by email provider systems 52. Web or application (“web/app”) servers 50 can enable online services including network-based applications, webpages, electronic message provider systems (e.g., email provider systems), or other online services accessible via a browser 62 or via a local application 64. The web/app servers 50 can further function to enable the local applications 64 or components of local applications 64. A user is enabled to engage an online service enabled by a web/app server 50 for example by registering a user account for which account credentials (e.g., username, password) are created by the user or an administrator of the online service.

Data monitored by the security agent 80 is fed by the security agent 80 to the security manager 20 via the agent API 28, and is stored in the intelligence datastore 38, beneficially in de-identified form, for training and threat detection via the intelligence engine 30. Monitored data can be further stored in the local datastore 66. The agent API 28 communicates with the security agent 80 via the computer network 8. Alternatively, the security manager 20 can be provided as an application on the computing device 12, for example as an integration or extension to the browser 62, and the security agent 80 can communicate locally with the security manager 20 via the agent API 28 on the computing device 12.

The security agent 80 can be provided integral with or as an extension or plugin to one or more email clients 60, one or more browsers 62, or the one or more local applications 64 and provides notices to a user via the user interface 68. The security agent 80 via the accessibility agent 72 monitors emails and other electronic communications from and to the email clients 60 and local applications 64. The security agent 80 further monitors user actions including logins, browsing history, and clickstreams from a browser 62 with which it is integrated or in communication with, which data is transmitted by the security agent 80 to the security manager 20 via the agent API 28, and stored in the intelligence datastore 38 to enable threat detection and model training via the intelligence engine 30.

The security manager 20 provides information for identifying threats to the security agent 80 via the agent API 28 for enabling the security agent 80 to provide notifications to a user and to filter or remove threats confronted by an email client 60, browser 62, or local application 64, which information is stored in the local datastore 66. The information for identifying threats includes rules for triggering the performance of screen captures based on text encodings. Threats can include links to webpages likely to enable scamming activity. Threats may be in the form of tracking URLs or URLs directed to a network locations hosting malware or computer viruses. An operating system 70 (hereinafter “OS 70”) is executed on the computing device 12 which enables integration of the security agent 80 and the accessibility agent 72 with one or more of an email client 60, a browser 62, or a local application 64. The security agent 80 and accessibility agent 72 are executed on a plurality of computing devices 12 of a plurality of users allowing aggregation by the security manager 20 of de-identified data from the plurality of computing devices 12.

The security agent 80 via the accessibility agent 72 is further enabled to provide data including screenshots to the security manager 20 during a technical support session enabled by the security manager 20 via the agent API 28 and a support engine 32. A user of a computing device 12 may desire to report a bug, an error, a computing threat, or other issue in an application, the application including for example a local application 64 or the security agent 80. To facilitate the reporting of an issue in an application, a user may need to perform a screen capture to generate a screenshot, for example showing an error message or the part of the application malfunctioning, to allow the support engine 32 or human or artificial intelligence technical support staff in communication with the security manager 20 to diagnose the problem to render assistance to the user. Alternatively, for sharing a service configuration and for troubleshooting purposes, the security manager 20 or technical support staff in communication with the security manager 20 may require a screenshot of specific settings on the computing device 12, like network configurations or accessibility options.

The security agent 80 is configured to apply one or more rules to a text encoding of a display screen of the user interface 68 during a technical support session or responsive to receiving a request from a user via the security agent 80 to the security manager 20 for technical support. The one or more applied rules include one or more rules to detect, based on a text encoding of display screen output encoded via the accessibility agent 72, when a particular output is visible on a display screen of a user interface 68 of a computing device 12 operated by a user. A rule can indicate that a screen capture should not be performed when any URLs are clipped or when other text is clipped in the display screen, since such information may be relevant to an analysis of the screenshot. A rule can further indicate that a screen capture should be performed when URLs are not clipped or when text is not clipped in the display screen. When the security agent 80 via the accessibility agent 72 determines based on the one or more rules that the particular output is visible on the display screen of the user interface 68, the security agent 80 alone or via the accessibility agent 72 performs a screen capture to generate a screenshot. The security agent 80 transmits the screenshot to the agent API 28 to be processed by the support engine 32 or rendered accessible to a technical support staff via the support engine 32. A technical support staff can access the screenshot for example using a support device 54 (e.g., a personal computer) via a support application program interface (“API”) 22.

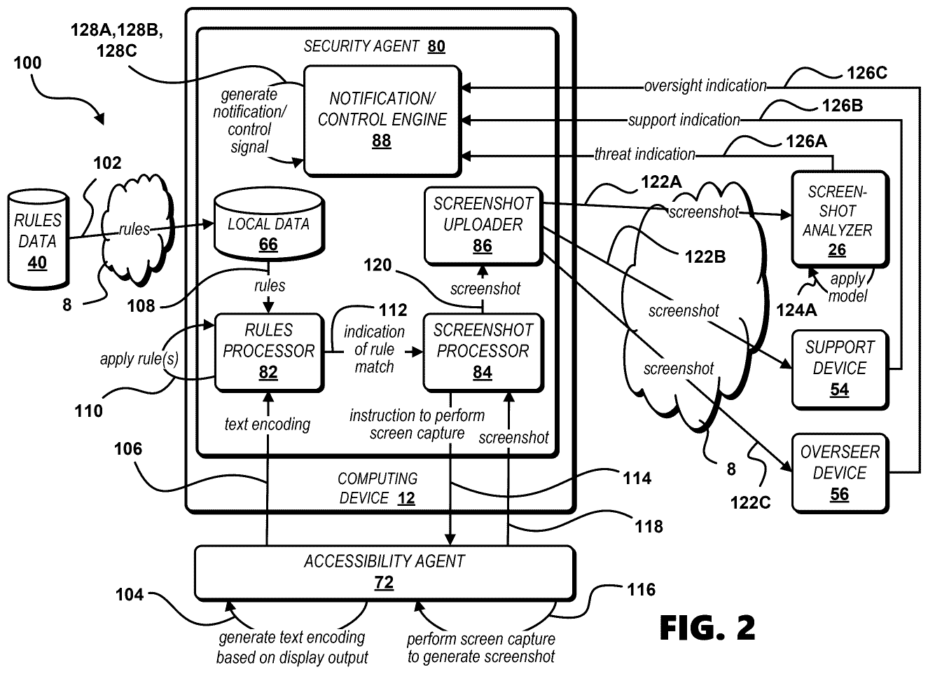

Referring to FIG. 2, a process flow 100 enabled by components of the environment 10 of FIG. 1 is provided. In a step 102, rules are transmitted from the rules datastore 40 via the agent API 28 to the security agent 80 for storage in the local datastore 66. The accessibility agent 72 generates a text encoding based on the output of the user interface 68 (step 104) and transmits the text encoding to a rules processor 82 of the security agent 80 (step 106). The rules processor 82 receives the text encoding, retrieves one or more rules from the local datastore 66 (step 108), and applies the one or more rules to the text encoding (step 110). If a match is determined by the rules processor 82 based on the application of the one or more rules, the rules processor 82 transmits an indication of a rule match to a screenshot processor 84 of the security agent 80 (step 112). As described herein, a rule match constitutes a trigger. The screenshot processor 84 receives the indication of a rule match from the rules processor 82 (step 112) and transmits an instruction to the accessibility agent 72 to perform a screen capture responsive to receiving the indication of a rule match (step 114). The accessibility agent 72 performs a screen capture responsive to receiving the instruction to perform a screen capture from the screenshot processor 84 to generate a screenshot (step 116). The accessibility agent 72 transmits the screenshot to the screenshot processor 84 (step 118), and the screenshot processor 84 provides the screenshot to the screenshot uploader 86 (step 120). The process flow 100 allows for conservation of computing resources including processing power, communication bandwidth, and data storage by limiting screen captures and transmission of screenshots based on one or more rules.

In a first implementation of the process flow 100, the screenshot uploader 86 transmits the screenshot to the screenshot analyzer 26 via the agent API 28 (step 122A). The screenshot analyzer 26 applies a model from the model datastore 36 to the screenshot to determine whether the screenshot corresponds to a computing threat (e.g., a phishing attempt) (step 124A), and if a computing threat is determined, the screenshot analyzer 26 via the agent API 28 transmits an indication of the computing threat to a notification/control engine 88 of the security agent 80 via the agent API 28 (step 126A). Alternatively, the screenshot processor 84 applies a model to determine whether the screenshot corresponds to a computing threat and transmits an indication of the computing threat to the notification/control engine 88. In the first implementation of the process flow 100, the notification/control engine 88 generates a signal for producing a notification via an email client 60, browser 62, or local application 64 and/or for controlling the email client 60, browser 62, or local application 64 responsive to receiving the indication of the computing threat (step 128A).

In an alternative, second implementation of the process flow 100, the screenshot uploader 86 transmits the screenshot to a support device 54 via the agent API 28, via the support engine 32, and via the support API 22 (step 122B). The support device 54, for example during a technical support session, via the support API 22, via the support engine 32, and via the agent API 28 transmits from a live agent (e.g., a human) or from an automated agent (e.g., an artificial intelligence agent) an indication related to technical support (e.g., application troubleshooting instructions) to the notification/control engine 88 (step 126B). In the second implementation of the process flow 100, the notification/control engine 88 generates a signal for producing a notification via an email client 60, browser 62, or local application 64 and/or for controlling the email client 60, browser 62, or local application 64 responsive to receiving the indication related to technical support (step 128B).

In an alternative, third implementation of the process flow 100, the screenshot uploader 86 transmits the screenshot to an overseer device 56 via the agent API 28, via the oversight engine 34, via the oversight API 24, and via the overseer agent 58 (step 122C). The overseer device 56 via the overseer agent 58, via the oversight API 24, via the oversight engine 34, and via the agent API 28 transmits, from a live person (e.g., a human) or automated agent (e.g., an artificial intelligence agent), an indication related to oversight to the notification/control engine 88 (step 126C). The indication related to oversight includes for example an indication that a communication represented by the screenshot is harassing or predatory to a user of the computing device 12. In the third implementation of the process flow 100, the notification/control engine 88 generates a signal for producing a notification via an email client 60, browser 62, or local application 64 and/or controlling the email client 60, browser 62, or local application 64 responsive to receiving the indication related to oversight (step 128C).

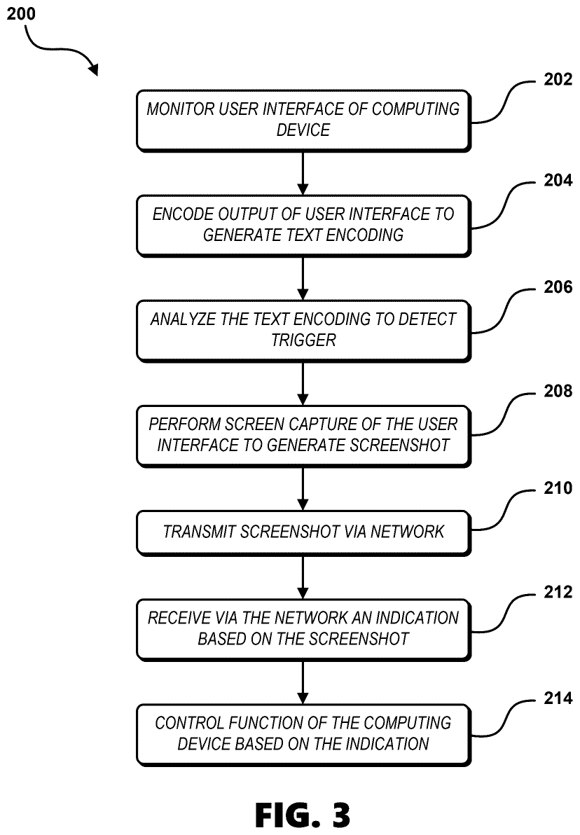

Referring to FIG. 3, a method 200 for detecting and mitigating a computing threat is provided. The method 200 is described with reference to the components of the environment 10, including the security manager 20 and computing devices 12 including respective security agents 80 and user interfaces 68 which enable the method 200. Alternatively, the method 200 can be performed via other computing devices and is not restricted to being implemented by the computing device 12 or other components included in the environment 10.

The method 200 includes monitoring, by a computing device 12, a user interface 68 of the computing device 12 (step 202). The computing device 12 encodes an output of the user interface 68 to generate a text encoding (step 204). The computing device 12 analyzes the text encoding to detect one or more triggers (step 206) and performs a screen capture of the user interface to generate a screenshot responsive to the detecting the one or more triggers (step 208). The computing device 12 transmits the screenshot via a network (step 210). The computing device 12 receives via the network an indication based on the screenshot (step 212) and controls a function of the computing device 12 based on the indication based on the screenshot (step 214). The method 200 allows for conservation of computing resources including processing power, communication bandwidth, and data storage at least by limiting screen captures and transmission of screenshots based on detection of one or more triggers.

Analyzing the text encoding can include searching the text encoding to detect the one or more triggers. Controlling the function of the computing device 12 can include disabling an application executed on the computing device 12. Controlling the function of the computing device 12 can alternatively or additionally include generating a notification in the user interface 68 of computing device 12.

In a particular implementation, the method 200 includes detecting, by the computing device 12, a user interface event of the computing device 12 based on the monitoring, and encoding, by the computing device 12, the output of the user interface 68 to generate the text encoding responsive to the detecting the user interface event. A user interface event as described herein is a change in content displayed by the user interface 68, whether caused by action of a user, an internal process of the computing device 12, a network-enabled process, or other process. The detecting the user interface event can include detecting an electronic message displayed in the user interface 68. In an alternative implementation, the detecting the user interface event can include detecting a browser window displayed in the user interface 68.

In a particular implementation of the method 200, the detecting the one or more triggers includes detecting a particular word. In an alternative implementation, the detecting the one or more triggers includes detecting a request to a user of the computing device 12 for information. One or more rules are applied to the text encoding to detect the one or more triggers, wherein the detecting the one or more triggers comprises satisfying the one or more rules. The encoding the output of the user interface 68 beneficially includes generating the text encoding as a tree structure including a plurality of objects, the method further beneficially including applying one or more rules to the tree structure to navigate the tree structure and to detect the one or more triggers.

In an extension to the method 200, a computing system, for example including the security manager 20, receives via the network the screenshot transmitted by the computing device 12. The computing system analyzes the screenshot to determine a quality of the screenshot and transmits to the computing device 12 the indication based on the screenshot based on the quality of the screenshot. The determined quality of the screenshot includes for example a classification of whether the screenshot corresponds to a malicious or threatening process or a benign process.

In another extension to the method 200, the computing device 12, provided as a first processing device, is operated by a first user. A second processing device, for example including the overseer device 56, receives via the network the screenshot, displays the screenshot, and receives from a second user a response based on the screenshot. The indication is generated, for example by the overseer device 56 or the security manager 20, based on the response based on the screenshot, and the indication is subsequently transmitted to the computing device 12, for example by the overseer device 56 via the security manager 20.

In another extension to the method 200, the computing device 12, provided as a first processing device, is operated by a first user. The first processing device initiates a communication session via the network between the first user and a second user. A second processing device, for example including the support device 54, receives the screenshot via the network, displays the screenshot, and receives from a second user a response based on the screenshot. The indication is generated, for example by the support device 54 or the security manager 20, based on the response based on the screenshot, and the indication is subsequently transmitted to the computing device 12, for example by the support device 54 via the security manager 20.

In a particular implementation, the method 200 further includes receiving from a plurality of devices a plurality of screenshots, training a model based on the plurality of screenshots from the plurality of devices, receiving via the network the screenshot from the computing device 12, applying the model to the screenshot from the computing device 12 to determine a quality of the screenshot from the computing device 12, and transmitting to the computing device 12 the indication based on the screenshot based on the quality of the screenshot.

In another particular implementation, the method 200 further includes monitoring, by a plurality of devices, a plurality of user interfaces of the plurality of devices. The plurality of devices encode a plurality of outputs of the plurality of user interfaces of the plurality of devices to generate a plurality of text encodings. The plurality of devices analyze the plurality of text encodings to detect one or more particular triggers. The plurality of devices perform a plurality of screen captures of the plurality of user interfaces of the plurality of devices to generate a plurality of screenshots of the plurality of user interfaces of the plurality of devices responsive to the detecting the one or more particular triggers. The plurality of devices transmit the plurality of screenshots of the plurality of user interfaces of the plurality of devices via the network. The particular implementation of the method 200 further includes receiving from the plurality of devices the plurality of screenshots of the plurality of user interfaces of the plurality of devices and training a model based on the plurality of screenshots of the plurality of user interfaces of the plurality of devices. The particular implementation of the method 200 further includes receiving via the network the screenshot from the computing device 12, applying the model to the screenshot from the computing device 12 to determine a quality of the screenshot from the computing device 12, and transmitting to the computing device 12 the indication based on the screenshot based on the quality of the screenshot. Beneficially, the plurality of devices detect a plurality of user interface events of the plurality of user interfaces of the plurality of devices, and the plurality of devices encode the plurality of outputs of the plurality of user interfaces of the plurality of devices to generate the plurality of text encodings respectively responsive to the detecting the plurality of user interface events of the plurality of user interfaces of the plurality of devices.

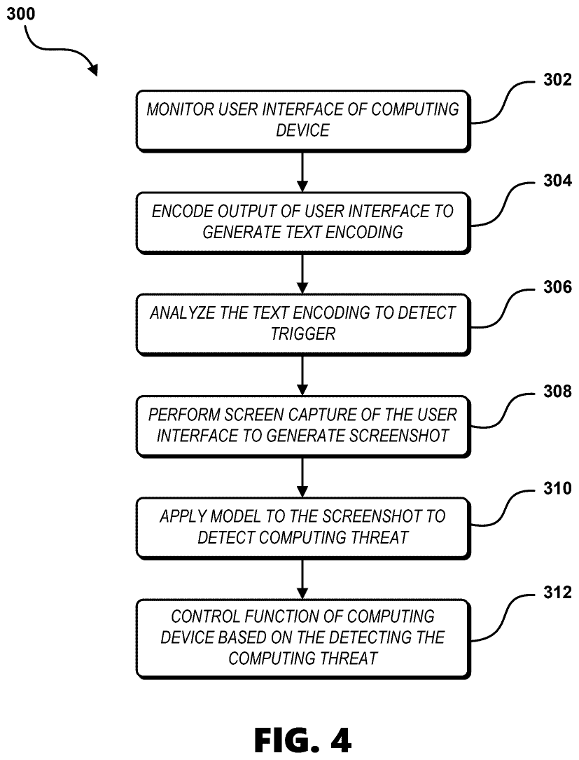

Referring to FIG. 4, a method 300 for mitigating a computing threat is provided. The method 300 is described with reference to the components of the environment 10, including the security manager 20 and computing devices 12 including respective security agents 80 and user interfaces 68 which enable the method 300. Alternatively, the method 300 can be performed via other computing devices and is not restricted to being implemented by the computing device 12 or other components included in the environment 10.

The method 300 includes monitoring a user interface 68 of a computing device 12 (step 302), encoding an output of the user interface 68 to generate a text encoding (step 304), analyzing the text encoding to detect one or more triggers (step 306), and performing a screen capture of the user interface 68 to generate a screenshot responsive to the detecting the one or more triggers (step 308). The method 300 further includes applying a model to the screenshot to detect a computing threat (step 310) and controlling a function of the computing device 12 based on the detecting the computing threat (step 312). In a particular implementation, the method 300 includes detecting a user interface event of the computing device 12 based on the monitoring, and the method 300 includes encoding the output of the user interface 68 to generate the text encoding responsive to the detecting the user interface event. The method 300 allows for conservation of computing resources including processing power, communication bandwidth, and data storage at least by limiting screen captures and application to a model on screenshots based on detection of one or more triggers.

An extension to the method 300 includes monitoring a plurality of user interfaces of a plurality of devices, encoding a plurality of outputs of the plurality of user interfaces of the plurality of devices to generate a plurality of text encodings, and analyzing the plurality of text encodings to detect one or more particular triggers. The extension to the method 300 also includes performing a plurality of screen captures of the plurality of user interfaces of the plurality of devices to generate a plurality of screenshots of the plurality of user interfaces of the plurality of devices responsive to the detecting the one or more particular triggers. The extension to the method 300 further includes training the model based on the plurality of screenshots of the plurality of user interfaces of the plurality of devices prior to applying the model to detect the computing threat. Beneficially, the extension to the method 300 further includes detecting a plurality of user interface events of the plurality of user interfaces of the plurality of devices and encoding the plurality of outputs of the plurality of user interfaces of the plurality of devices to generate the plurality of text encodings respectively responsive to the detecting the plurality of user interface events of the plurality of user interfaces of the plurality of devices.

Referring to FIG. 1, the environment 10 enables a network-enabled threat mitigation system including a first computing system, including for example the computing device 12, including at least a first processor and at least a first non-transitory computer readable storage medium having encoded thereon first instructions that when executed by the at least the first processor cause the first computing system to perform a first process. The first process includes monitoring a user interface of the first computing system and encoding an output of the user interface to generate a text encoding. The first process can further include detecting a user interface event of the first computing system based on the monitoring and encoding the output of the user interface to generate the text encoding responsive to the detecting the user interface event. The first process also includes analyzing the text encoding to detect one or more triggers, performing a screen capture of the user interface to generate a screenshot responsive to the detecting the one or more triggers, and transmitting the screenshot via a network. The first process further includes receiving via the network an indication based on the screenshot and controlling a function of the first computing system based on the indication based on the screenshot.

The network-enabled threat mitigation system further includes a second computing system, for example including one or more of the security manager 20, support device 54, or overseer device 56, including at least a second processor and at least a second non-transitory computer readable storage medium having encoded thereon second instructions that when executed by the at least the second processor cause the second computing system to perform a second process. The second process includes receiving via the network the screenshot, analyzing the screenshot to determine a quality of the screenshot, and transmitting to the first computing system the indication based on the screenshot based on the quality of the screenshot. Alternatively, the second process includes receiving via the network the screenshot, displaying the screenshot, and receiving from a second user a response based on the screenshot, wherein the indication is based on the response based on the screenshot. Alternatively, the second process includes engaging in a communication session via the network between a first user at the first computing system and a second user at the second computing system, receiving via the network the screenshot, displaying the screenshot, and receiving from the second user a response based on the screenshot, wherein the indication is based on the response based on the screenshot.

The security agent 80 is enabled by a non-transitory computer-readable storage medium storing executable instructions that, as a result of execution by one or more processors of a computing device 12, cause the computing device 12 to perform operations. The operations include monitoring a user interface of the computing device 12 and encoding an output of the user interface to generate a text encoding. The operations also include analyzing the text encoding to detect one or more triggers, performing a screen capture of the user interface to generate a screenshot responsive to the detecting the one or more triggers, and transmitting the screenshot via a network. The operations further include receiving via the network an indication based on the screenshot and controlling a function of the computing device 12 based on the indication based on the screenshot. The operations can further include detecting a user interface event of the computing device 12 based on the monitoring and encoding the output of the user interface to generate the text encoding responsive to the detecting the user interface event. The operations can further include steps described herein with respect to the method 200 and method 300.

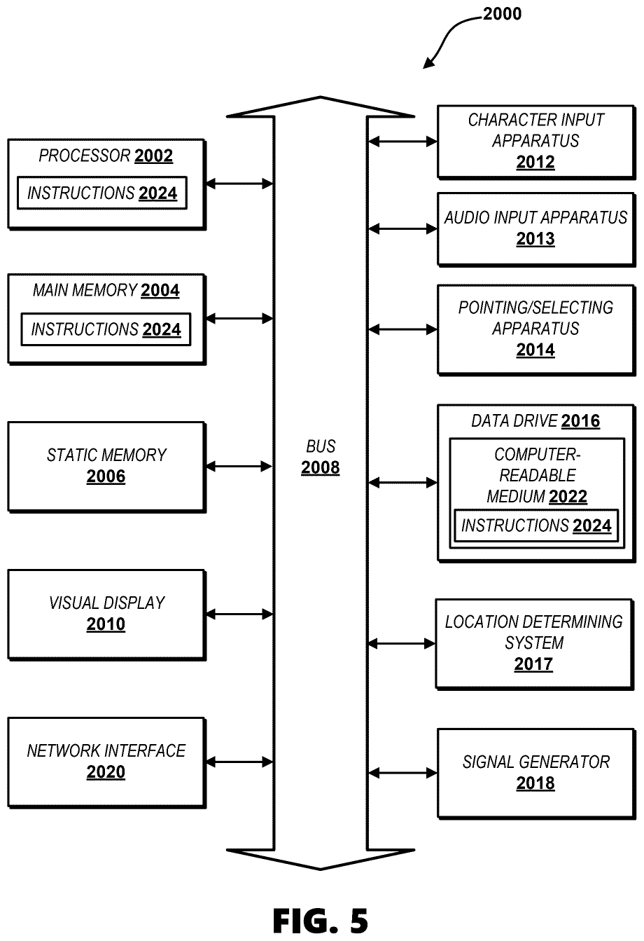

FIG. 5 illustrates in abstract the function of an exemplary computer system 2000 on which the systems, methods and processes described herein can execute. For example, the computing device 12, security manager 20, web/app servers 50, email provider systems 52, support device 54, and overseer device 56 can each be embodied by a particular computer system 2000 or a plurality of computer systems 2000. The computer system 2000 may be provided in the form of a personal computer, laptop, handheld mobile communication device, mainframe, distributed computing system, or other suitable configuration. Illustrative subject matter is in some instances described herein as computer-executable instructions, for example in the form of program modules, which program modules can include programs, routines, objects, data structures, components, or architecture configured to perform particular tasks or implement particular abstract data types. The computer-executable instructions are represented for example by instructions 2024 executable by the computer system 2000.

The computer system 2000 can operate as a standalone device or can be connected (e.g., networked) to other machines. In a networked deployment, the computer system 2000 may operate in the capacity of a server or a client machine in a server-client network environment, or as a peer machine in a peer-to-peer (or distributed) network environment. The computer system 2000 can also be considered to include a collection of machines that individually or jointly execute a set (or multiple sets) of instructions to perform one or more of the methodologies described herein, for example in a cloud computing environment.

It would be understood by those skilled in the art that other computer systems including but not limited to networkable personal computers, minicomputers, mainframe computers, handheld mobile communication devices, multiprocessor systems, microprocessor-based or programmable electronics, and smart phones could be used to enable the systems, methods and processes described herein. Such computer systems can moreover be configured as distributed computer environments where program modules are enabled and tasks are performed by processing devices linked through a computer network, and in which program modules can be located in both local and remote memory storage devices.

The exemplary computer system 2000 includes a processor 2002, for example a central processing unit (CPU) or a graphics processing unit (GPU), a main memory 2004, and a static memory 2006 in communication via a bus 2008. A visual display 2010 for example a liquid crystal display (LCD), a light emitting diode (LED) display, or a cathode ray tube (CRT) is provided for displaying data to a user of the computer system 2000. The visual display 2010 can be enabled to receive data input from a user, for example via a resistive or capacitive touch screen. A character input apparatus 2012 can be provided for example in the form of a physical keyboard, or alternatively, a program module which enables a user-interactive simulated keyboard on the visual display 2010 and actuatable for example using a resistive or capacitive touchscreen. An audio input apparatus 2013, for example a microphone, enables audible language input which can be converted to textual input by the processor 2002 via the instructions 2024. A pointing/selecting apparatus 2014 can be provided, for example in the form of a computer mouse or enabled via a resistive or capacitive touch screen in the visual display 2010. A data drive 2016, a signal generator 2018 such as an audio speaker, and a network interface 2020 can also be provided. A location determining system 2017 is also provided which can include for example a GPS receiver and supporting hardware.

The instructions 2024 and data structures embodying or used by the herein-described systems, methods, and processes, for example software instructions, are stored on a computer-readable medium 2022 and are accessible via the data drive 2016. Further, the instructions 2024 can completely or partially reside for a particular time period in the main memory 2004 or within the processor 2002 when the instructions 2024 are executed. The main memory 2004 and the processor 2002 are also as such considered computer-readable media.

While the computer-readable medium 2022 is shown as a single medium, the computer-readable medium 2022 can be considered to include a single medium or multiple media, for example in a centralized or distributed database, or associated caches and servers, that store the instructions 2024. The computer-readable medium 2022 can be considered to include any tangible medium that can store, encode, or carry instructions for execution by a machine and that cause the machine to perform any one or more of the methodologies described herein, or that can store, encode, or carry data structures used by or associated with such instructions. Further, the term “computer-readable storage medium” can be considered to include, but is not limited to, solid-state memories and optical and magnetic media that can store information in a non-transitory manner. Computer-readable media can for example include non-volatile memory such as semiconductor memory devices (e.g., magnetic disks such as internal hard disks and removable disks, magneto-optical disks, CD-ROM and DVD-ROM disks, Erasable Programmable Read-Only Memory (EPROM), Electrically Erasable Programmable Read-Only Memory (EEPROM), and flash memory devices).

The instructions 2024 can be transmitted or received over a computer network, for example the computer network 8, using a signal transmission medium via the network interface 2020 operating under one or more known transfer protocols, for example FTP, HTTP, or HTTPs. Examples of computer networks include a local area network (LAN), a wide area network (WAN), the internet, mobile telephone networks, Plain Old Telephone (POTS) networks, and wireless data networks, for example Wi-Fi™ and 3G/4G/5G cellular networks. The term “computer-readable signal medium” can be considered to include any transitory intangible medium that is capable of storing, encoding, or carrying instructions for execution by a machine, and includes digital or analog communications signals or other intangible medium to facilitate communication of such instructions.

Although features and elements are described above in particular combinations, one of ordinary skill in the art will appreciate that each feature or element can be used alone or in any combination with the other features and elements. Methods described herein may be implemented in a computer program, software, or firmware incorporated in a computer-readable medium for execution by a computer or processor.

While embodiments have been described in detail above, these embodiments are non-limiting and should be considered as merely exemplary. Modifications and extensions may be developed, and all such modifications are deemed to be within the scope defined by the appended claims.

What is claimed is:

1. A method comprising:
monitoring, by a computing device, a user interface of the computing device;
encoding, by the computing device, an output of the user interface to generate a text encoding;
analyzing, by the computing device, the text encoding to detect at least one trigger;
performing, by the computing device, a screen capture of the user interface to generate a screenshot responsive to the detecting the at least one trigger;
transmitting, by the computing device, the screenshot via a network;
receiving, by the computing device, via the network an indication based on the screenshot; and
controlling, by the computing device, a function of the computing device based on the indication based on the screenshot.

2. The method of claim 1, wherein the analyzing the text encoding comprises searching the text encoding to detect the at least one trigger.

3. The method of claim 1, further comprising:
detecting, by the computing device, a user interface event of the computing device based on the monitoring; and
encoding, by the computing device, the output of the user interface to generate the text encoding responsive to the detecting the user interface event.

4. The method of claim 3, wherein the detecting the user interface event comprises detecting an electronic message displayed in the user interface.

5. The method of claim 3, wherein the detecting the user interface event comprises detecting a browser window displayed in the user interface.

6. The method of claim 1, wherein the detecting the at least one trigger comprises detecting a particular word.

7. The method of claim 1, wherein the detecting the at least one trigger comprises detecting a request to a user of the computing device for information.

8. The method of claim 1, further comprising applying at least one rule to the text encoding to detect the at least one trigger, wherein the detecting the at least one trigger comprises satisfying the at least one rule.

9. The method of claim 1, wherein the encoding the output of the user interface comprises generating the text encoding as a tree structure comprising a plurality of objects, the method further comprising applying at least one rule to the tree structure to navigate the tree structure and to detect the at least one trigger.

10. The method of claim 1, further comprising:
receiving by a computing system via the network the screenshot;
analyzing the screenshot by the computing system to determine a quality of the screenshot; and
transmitting by the computing system to the computing device the indication based on the screenshot based on the quality of the screenshot.

11. The method of claim 1, wherein the computing device comprises a first processing device and is operated by a first user, the method further comprising:
receiving by a second processing device via the network the screenshot;
displaying by the second processing device the screenshot;
receiving by the second processing device from a second user a response based on the screenshot; and
generating the indication based on the response based on the screenshot.

12. The method of claim 1, wherein the computing device comprises a first processing device and is operated by a first user, the method further comprising:
initiating by the first processing device a communication session via the network between the first user and a second user;
receiving by a second processing device via the network the screenshot;
displaying by the second processing device the screenshot;
receiving by the second processing device from the second user a response based on the screenshot; and
generating the indication based on the response based on the screenshot.

13. The method of claim 1, wherein the controlling the function of the computing device comprises disabling an application executed on the computing device.

14. The method of claim 1, wherein the controlling the function of the computing device comprises generating a notification in the user interface.

15. The method of claim 1, further comprising:
receiving from a plurality of devices a plurality of screenshots;
training a model based on the plurality of screenshots from the plurality of devices;
receiving via the network the screenshot from the computing device;
applying the model to the screenshot from the computing device to determine a quality of the screenshot from the computing device; and
transmitting to the computing device the indication based on the screenshot based on the quality of the screenshot.

16. The method of claim 1, further comprising
monitoring, by a plurality of devices, a plurality of user interfaces of the plurality of devices;
encoding, by the plurality of devices, a plurality of outputs of the plurality of user interfaces of the plurality of devices to generate a plurality of text encodings;
analyzing, by the plurality of devices, the plurality of text encodings to detect one or more particular triggers;
performing, by the plurality of devices, a plurality of screen captures of the plurality of user interfaces of the plurality of devices to generate a plurality of screenshots of the plurality of user interfaces of the plurality of devices responsive to the detecting the one or more particular triggers;
transmitting, by the plurality of devices, the plurality of screenshots of the plurality of user interfaces of the plurality of devices via the network;
receiving from the plurality of devices the plurality of screenshots of the plurality of user interfaces of the plurality of devices;
training a model based on the plurality of screenshots of the plurality of user interfaces of the plurality of devices;
receiving via the network the screenshot from the computing device;
applying the model to the screenshot from the computing device to determine a quality of the screenshot from the computing device; and
transmitting to the computing device the indication based on the screenshot based on the quality of the screenshot.

17. The method of claim 16, further comprising:
detecting, by the plurality of devices, a plurality of user interface events of the plurality of user interfaces of the plurality of devices; and
encoding, by the plurality of devices, the plurality of outputs of the plurality of user interfaces of the plurality of devices to generate the plurality of text encodings respectively responsive to the detecting the plurality of user interface events of the plurality of user interfaces of the plurality of devices.

18. A computing threat mitigation method comprising:
monitoring a user interface of a computing device;
encoding an output of the user interface to generate a text encoding;
analyzing the text encoding to detect at least one trigger;
performing a screen capture of the user interface to generate a screenshot responsive to the detecting the at least one trigger;
applying a model to the screenshot to detect a computing threat; and
controlling a function of the computing device based on the detecting the computing threat.

19. The method of claim 18, further comprising:
detecting a user interface event of the computing device based on the monitoring; and
encoding the output of the user interface to generate the text encoding responsive to the detecting the user interface event.

20. The method of claim 18, further comprising:
monitoring a plurality of user interfaces of a plurality of devices;
encoding a plurality of outputs of the plurality of user interfaces of the plurality of devices to generate a plurality of text encodings;
analyzing the plurality of text encodings to detect one or more particular triggers;
performing a plurality of screen captures of the plurality of user interfaces of the plurality of devices to generate a plurality of screenshots of the plurality of user interfaces of the plurality of devices responsive to the detecting the one or more particular triggers; and
training the model based on the plurality of screenshots of the plurality of user interfaces of the plurality of devices prior to applying the model to detect the computing threat.

21. The method of claim 20, further comprising:
detecting a plurality of user interface events of the plurality of user interfaces of the plurality of devices; and
encoding the plurality of outputs of the plurality of user interfaces of the plurality of devices to generate the plurality of text encodings respectively responsive to the detecting the plurality of user interface events of the plurality of user interfaces of the plurality of devices.

22. A network-enabled threat mitigation system comprising a first computing system comprising at least a first processor and at least a first non-transitory computer readable storage medium having encoded thereon first instructions that when executed by the at least the first processor cause the first computing system to perform a first process comprising:
monitoring a user interface of the first computing system;
encoding an output of the user interface to generate a text encoding;
analyzing the text encoding to detect at least one trigger;
performing a screen capture of the user interface to generate a screenshot responsive to the detecting the at least one trigger;
transmitting the screenshot via a network;
receiving via the network an indication based on the screenshot; and
controlling a function of the first computing system based on the indication based on the screenshot.

23. The network-enabled threat mitigation system of claim 22 further comprising a second computing system comprising at least a second processor and at least a second non-transitory computer readable storage medium having encoded thereon second instructions that when executed by the at least the second processor cause the second computing system to perform a second process comprising:
receiving via the network the screenshot;
analyzing the screenshot to determine a quality of the screenshot; and
transmitting to the first computing system the indication based on the screenshot based on the quality of the screenshot.

24. The network-enabled threat mitigation system of claim 22 further comprising a second computing system comprising at least a second processor and at least a second non-transitory computer readable storage medium having encoded thereon second instructions that when executed by the at least the second processor cause the second computing system to perform a second process comprising:
receiving via the network the screenshot;
displaying the screenshot; and
receiving from a second user a response based on the screenshot;
wherein the indication is based on the response based on the screenshot.

25. The network-enabled threat mitigation system of claim 22 further comprising a second computing system comprising at least a second processor and at least a second non-transitory computer readable storage medium having encoded thereon second instructions that when executed by the at least the second processor cause the second computing system to perform a second process comprising:
engaging in a communication session via the network between a first user at the first computing system and a second user at the second computing system;
receiving via the network the screenshot;
displaying the screenshot; and
receiving from the second user a response based on the screenshot;
wherein the indication is based on the response based on the screenshot.

26. A non-transitory computer-readable storage medium storing executable instructions that, as a result of execution by one or more processors of a computing device, cause the computing device to perform operations comprising:
monitoring a user interface of the computing device;
encoding an output of the user interface to generate a text encoding;
analyzing the text encoding to detect at least one trigger;
performing a screen capture of the user interface to generate a screenshot responsive to the detecting the at least one trigger;
transmitting the screenshot via a network;
receiving via the network an indication based on the screenshot; and
controlling a function of the computing device based on the indication based on the screenshot.
